(19) United States
(12) Patent Application Publication
(10) Pub. No.: US 2006/0201637 A1
(43) Pub. Date: Sep. 14, 2006

(54) Non-pull cord operated venetian blind structure

(76) Inventor: Leslie Nien, Fuxing Shiang (TW)

Correspondence Address: TROXELL LAW OFFICE PLLC, SUITE 1404, 5205 LEESBURG PIKE, FALLS CHURCH, VA, 22041, US

(21) Appl. No.: 11/120,977

(22) Filed: May 4, 2005

(30) Foreign Application Priority Data
Mar. 11, 2005 (TW) 094203812

(51) Int. Cl. E06B 9/30

(52) U.S. Cl. 160/170

(57) ABSTRACT

A non-pull cord operated Venetian blind structure includes a control rotary housing, a retaining member, a recoiling body, a rotary ring, and a rotating body wherein the control rotary housing has a protrusive portion with an annular assembly hole extending in the middle thereof, a retaining thru-hole appropriately disposed at one side thereof, and a higher/lower stepwise stop flange annularly disposed at an appropriate position therein. The retaining member has a central engaging rod extending at the outer side thereon, and an adjusting toothed block appropriately disposed therein. The recoiling body is made up of an upper board, a separation board, a lower board to form a set of first and second cord-collecting spaces thereby wherein multiple toothed blocks are annularly arranged at predetermined positions of the upper board thereon, and multiple abutting blocks with engaging hooks are annularly disposed around the periphery of an engaging cylinder of the recoiling body thereof. The rotary ring has a cord-passage space disposed thereon, and a set of upper and lower coupling sections with inserting flanges extending thereon. The rotating body has a plurality of coupling flanges disposed at predetermined positions of an engaging cavity thereon, and a central limiting ring to circumscribe a coupling rod in the middle thereof. Therefore, a retaining cord guided through slats of a Venetian blind can be directly collected at or released from the recoiling body thereof without any pulling cords exposed outside so as to avoid hurting or strangling children, achieving more convenient and safer application of the present invention.

### BACKGROUND OF THE INVENTION

The present invention is related to a non-pull cord operated Venetian blind structure, including a control rotary housing, a retaining member, a recoiling body, a rotary ring, and a rotating body that are reciprocally assembled in an operative mechanism to be mounted to a bottom rail of a Venetian blind thereby so that a retaining cord guided through slats of the Venetian blind can be directly collected at or released from cord-collecting spaces of the recoiling body thereof so as to raise or expand the Venetian blind thereby without any pulling cords exposed outside, efficiently avoiding the danger of accidentally hurting or strangling children in the family to achieve more convenient and safer application of the present invention.

A conventional Venetian blind is usually made up of a gearing-wheel unit in an operative mechanism with a pull cord set and a rope ladder set, which is not only tedious and time-consuming in the assembly thereof, but also quite dangerous in application thereof. Once the Venetian blind is raised up in a collected position thereof, the pull cord will be suspended downwards for a certain length, and children playing around can easily get caught by the pull cord exposed outside. In case the pull cord is carelessly released to expand the Venetian blind thereof, the withdrawing pull cord can easily hurt or strangle the children got caught in it. Thus, the conventional Venetian blind poses a potential danger in application thereof.

### SUMMARY OF THE PRESENT INVENTION

It is, therefore, the primary purpose of the present invention to provide a non-pull cord operated Venetian blind structure, including a control rotary housing, a retaining member, a recoiling body, a rotary ring, and a rotating body that are reciprocally assembled in an operative mechanism and mounted to a bottom rail of a Venetian blind thereby so that a retaining cord guided through slats of the Venetian blind can be directly collected at or released from cord-collecting spaces of the recoiling body thereof so as to raise or expand the Venetian blind thereby without any pulling cords exposed outside, efficiently avoiding the danger of accidentally hurting or strangling children in the family to achieve more convenient and safer application of the present invention.

### BRIEF DESCRIPTION OF THE DRAWINGS

FIG. 1 is an exploded perspective view of the present invention.

FIG. 2 is a partially enlarged and perspective view of the present invention.

FIG. 3 is another partially enlarged and perspective view of the present invention.

FIG. 4 is an assembled perspective view of the present invention with a retaining cord applied thereto.

FIG. 5 is a cross sectional view of the present invention in assembly.

FIG. 6 is a partially cross sectional view of the present invention in assembly.

FIG. 7 is a cross sectional view of the present invention in operation.

FIG. 8 is a diagram showing the retaining cord wound around a recoiling body of the present invention.

FIG. 9 is a plane view of the present invention mounted to a Venetian blind.

FIG. 10 is a diagram showing an operation of the present invention.

FIG. 11 is another diagram showing the operation of present invention in FIG. 10.

FIG. 12 is a diagram showing another operation of the present invention in the expansion of the Venetian blind thereof.

FIG. 13 is another diagram showing the operation of the present invention in FIG. 12.

FIG. 14 is a third diagram showing the operation of the present invention in FIG. 12.

### DETAILED DESCRIPTION OF THE PREFERRED EMBODIMENTS

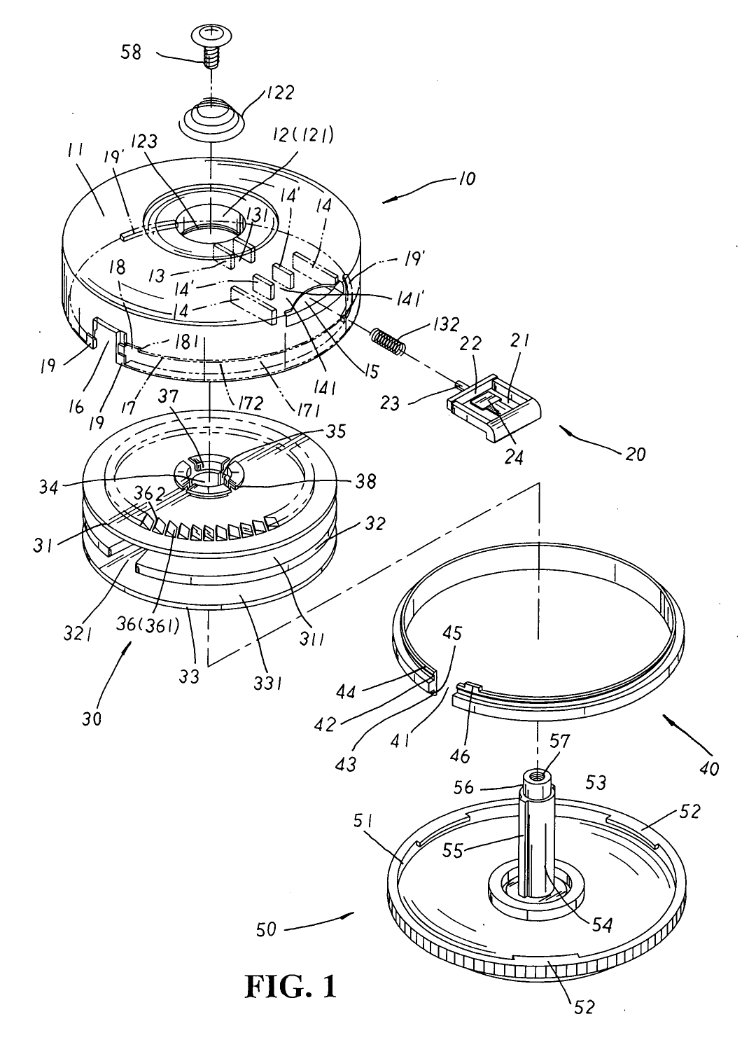

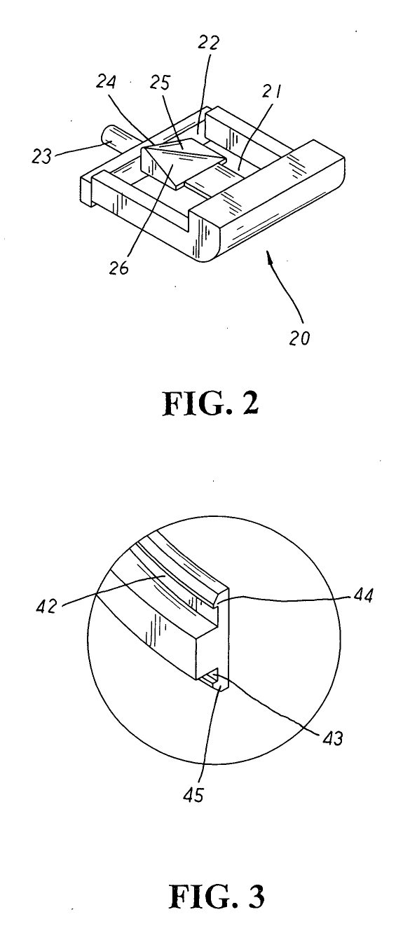

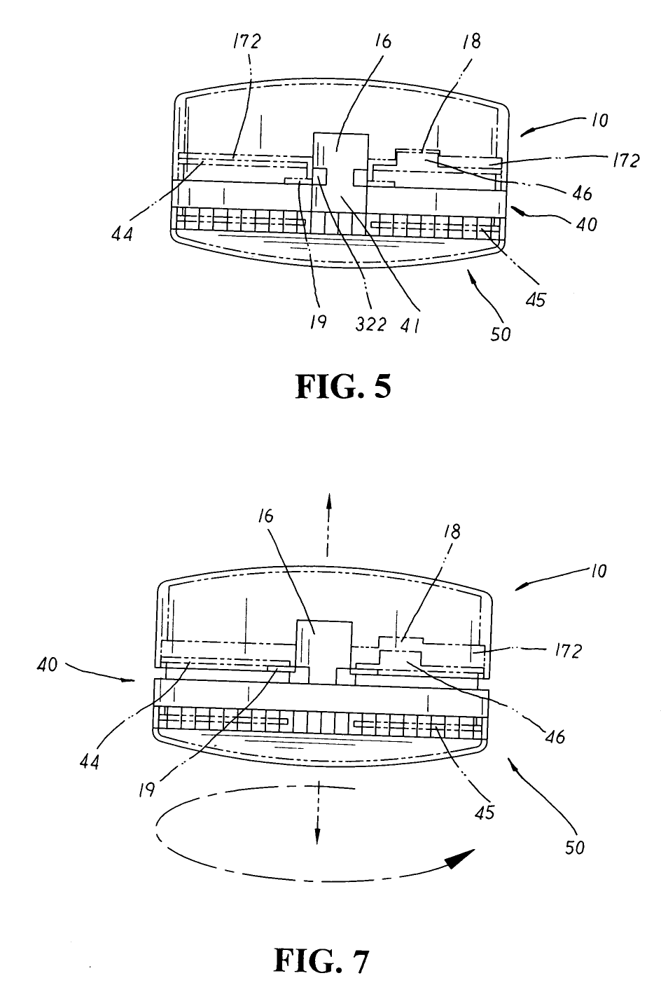

Please refer to FIG. 1. The present invention is related to a non-pull cord operated Venetian blind structure, including a control rotary housing 10, a retaining member 20, a recoiling body 30, a rotary ring 40, and a rotating body 50. The control rotary housing 10 is equipped with a receiving space 11 defining therein to match with the recoiling body 30 thereof, and a central protrusive portion 12 with a circular assembly hole 121 extending in the middle thereof for the accommodation of a spring element 122 therein and an abutting edge 123 annularly defining the bottom end of the protrusive portion 12 thereof. A pair of protrusive ribs 13 symmetrically extends at the inner top wall of the control rotary housing 10 thereof to define a positioning space 131 there-between for receiving a matched elastic element 132 therein. Correspondingly relative to the protrusive ribs 13 thereof is disposed a set of symmetrical first and second locating ribs 14, 14′ to define a set of first and second retaining spaces 141, 141′ respectively thereby. A retaining thru-hole 15 is appropriately disposed at one side of the control rotary housing 10 thereof for the guiding of the retaining member 20 there-through, and a cord-passage opening 16 is cut at a predetermined position at the outer periphery of the control rotary hosing 10 thereon. A higher/lower stepwise stop flange 17 is annularly disposed defining appropriate positions at the inner wall of the control rotary housing 10 thereof to form an engaging pace 171 and a movement space 172 thereby. A pair of inserting grooves 18 each defined by limiting sidewalls 181 is symmetrically set at appropriate positions of the higher/lower stepwise stop flange 17 thereon, and a plurality of positioning blocks 19, 19′ are disposed at predetermined positions thereof. The retaining member 20 is equipped with a slot 21, a stop facet 22 disposed at one side thereof, and an engaging rod 23 extending in the middle of the outer edge thereof to be reciprocally registered with the elastic element 132 adapted at the positioning space 131 of the control rotary housing 10 therein. In the middle section of the retaining member 24 is disposed an adjusting toothed block 24 having a plurality of right-angled triangular oblique faces 25, 26 defining thereon as shown in FIG. 2. The recoiling body 30 is formed in a three-stepwise disk shape and made up of an upper board 31, a separation board 32, and a lower board 33 to divide a set of first and second cord-collecting spaces 311, 331 respectively thereby. In the middle of the recoiling body 30 is disposed an engaging cylinder 34 having a pair of limiting recesses 35 symmetrically defining thereon. A plurality of right-angled triangular toothed blocks 36 are annularly arranged at predetermined positions at the top surface of the upper board 31 thereon to form a plurality of registration spaces 361 and retaining faces 362 thereby so as to reciprocally match with the oblique faces 25, 26 of the adjusting toothed block 24 thereof for the abutting location of the retaining member 20 thereby. Around the upper edge of the engaging cylinder 34 thereof is annularly disposed a plurality of abutting blocks 37 having a plurality of engaging hooks 38 extending thereon to be reciprocally engaged with the abutting edge 123 of the protrusive portion 12 of the control rotary housing 10 thereby. The separation board 32 of the recoiling body 30 has a cord-passing recess 321 with a symmetrical retaining groove 322 (referring to FIG. 5) disposed at a predetermined position therein to communicate with the first and the second cord-collecting spaces 311, 331 thereby. The rotary ring 40 has a cord-passing space 41 appropriately disposed thereon to reciprocally match with the cord-passage opening 16 of the control rotary housing 10 and the cord-passing recess 321 of the separation board 32 of the recoiling body 30 thereby. The rotary ring 40 also includes a set of upper and lower inserting flanges 44, 45 (referring to FIG. 3) disposed at a set of upper and lower coupling sections 42, 43 thereon, and a locating block 46 properly extending at the inserting flange 44 of the upper coupling section 42 thereon adjacent to the cord-passing space 41 thereof. The rotating body 50 has an engaging cavity 51 indented at the upper side thereof, a plurality of coupling flanges 52 extending annularly at predetermined positions of the engaging cavity 51 thereon to be reciprocally engaged with the lower inserting flange 45 defining the lower coupling section 43 of the rotary ring 40 thereof. The rotary body 50 also includes a limiting ring 53 annularly protruding at the center thereon, a central coupling rod 54 circumscribed by the limiting ring 53 therein, a pair of inserting ribs 55 symmetrically extending at the outer surface of the coupling rod 53 thereon, and an engaging portion 56 with a screw hole 57 defined therein at the upper end of the coupling rod 53 thereof to be reciprocally locked to a fixing member 58 thereby.

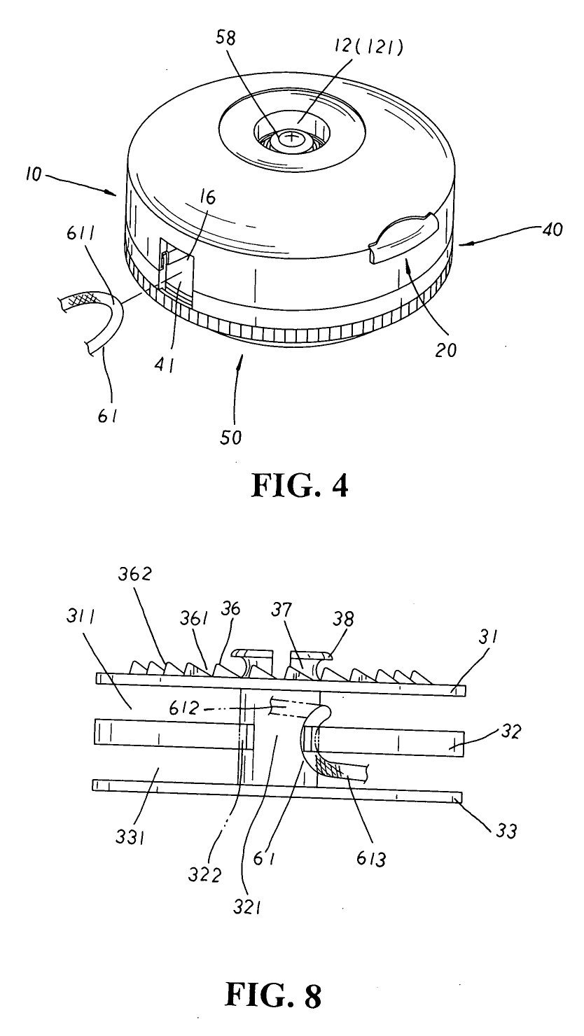

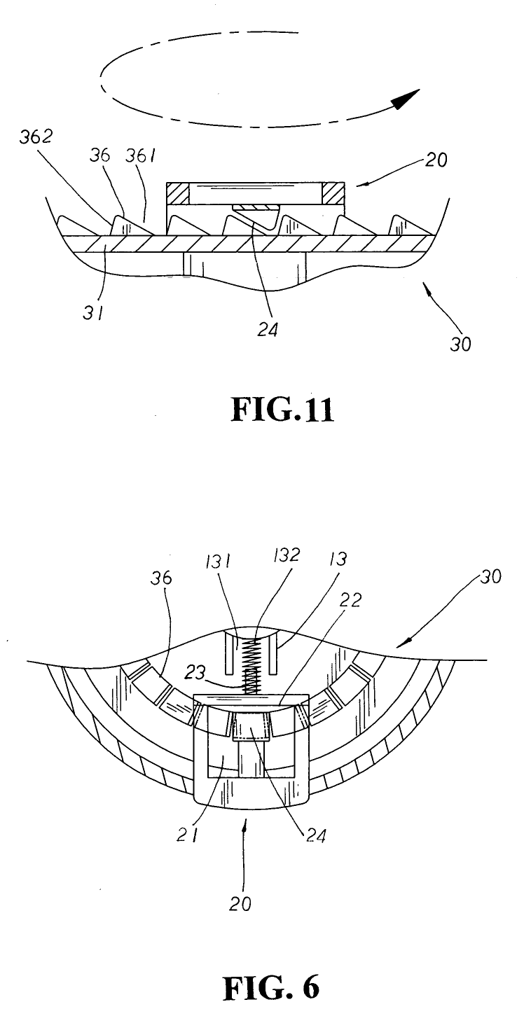

Please refer to FIGS. 4 to 5 inclusive. In assembly, the elastic element 132 is accommodated into the positioning space 131 defined by the protrusive ribs 13 of the control rotary housing 10 thereof, and the retaining member 20 is guided through the retaining thru-hole 15 thereof to locate at the retaining space 141 defined by the first locating ribs 14 therein, permitting the engaging rod 23 of the retaining member 20 to precisely register with one end of the elastic element 132 thereof as shown in FIG. 6 and the adjusting toothed block 24 extending at the slot 21 of the retaining member 20 therein to situate at the retaining space 141′ defined by the second locating ribs 14′ thereof with the stop facet 22 thereof accurately abutted against the sidewalls of the second locating ribs 14′ thereof for mutual abutting location thereby. Then, the abutting blocks 37 defining the top periphery of the engaging cylinder 34 of the recoiling body 30 is accommodated into the assembly hole 121 of the protrusive portion 12 of the control rotary housing 10 so as to mount the recoiling body 30 into the receiving space 11 of the control rotary housing 10 thereby, permitting the engaging hooks 38 of the abutting blocks 37 thereof to precisely engage with the abutting edge 123 of the protrusive portion 12 thereof for secure mutual abutting location thereby, and the engaging cylinder 34 thereof to reciprocally communicate with the assembly hole 121 thereof. The upper coupling section 42 of the rotary ring 40 is mounted to the engaging space 171 defined by the higher/lower stepwise stop flange 17 of the control rotary housing 10 thereof with the locating block 46 precisely joined to the inserting groove 18 and limited therein via the sidewalls 181 defining both sides of the inserting groove 18 thereof, and the cord-passing space 41 correspondingly aligned with the cord-passage opening 16 of the control rotary housing 10 in mutual communication therewith. Then, the coupling rod 54 of the rotating body 50 is guided through the engaging cylinder 34 of the recoiling body 30 with the inserting ribs 55 precisely located at the limiting recesses 35 therein in secure engagement therewith, permitting the limiting ring 53 thereof to abut against one side of the lower board 33 of the recoiling body 30, and the engaging portion 56 extending at the top end of the coupling rod 54 to sequentially extend through the engaging cylinder 34 of the recoiling body 30 and the assembly hole 121 of the control rotary housing 10 thereof. Meanwhile, the coupling flanges 52 of the rotating body 50 are tightly hooked to the inserting flange 45 of the lower coupling section 43 of the rotary ring 40 in secure mutual engagement therewith. Then, the spring element 122 is mounted to the assembly hole 121 of the control rotary housing 10 to accommodate at the abutting blocks 37 of the recoiling body 30 thereon, and the fixing member 58 of the rotating body 50 is locked to the screw hole 57 thereof to complete the assembly of the present invention.

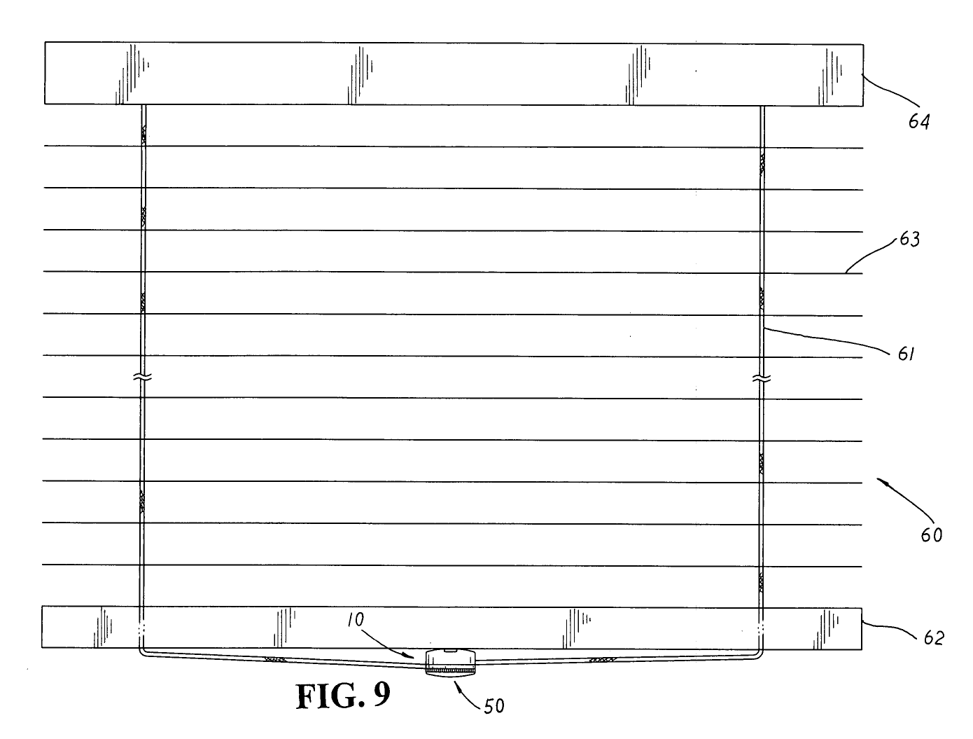

In practical use, the rotating body 50 is rotated to one side to synchronically actuate the recoiling body 30 therewith, permitting the cord-passing recess 321 of the separation board 32 thereof to correspondingly align and communicate with the cord-passage opening 16 of the control rotary housing 10 and the cord-passing space 41 of the rotary ring 40 thereof. A retaining cord 61 of a Venetian blind 60 is then folded in double to form an enclosing end 611 (referring to FIG. 4) that are led through the cord-passage opening 16 and the cord-passing space 41 thereof respectively and guided through the cord-passing recess 321 of the separation board 32 to hook at the retaining groove 322 therein. Then, the rotary ring 40 and the rotating body 50 are synchronically pulled downward (referring to FIG. 7), permitting the inserting flange 44 of the upper coupling section 42 thereof to abut against the positioning blocks 19, 19′ of the control rotary housing 10 without the rotary ring 40 being dislocated from the control rotary housing 10 thereof. The rotary ring 40 along with the rotating body 50 is rotated counterclockwise to slide the locating block 46 of the rotary ring 40 at the movement space 172 defined by the higher/lower stepwise stop flange 17 of the control rotary housing 10 therein till the cord-passage opening 16 of the control rotary housing 10 to align in a straight line with the cord-passing space 41 of the rotary ring 40 thereof. Via the recoiling body 30 actuated to rotate by the rotating body 50 thereof, both free ends 612, 613 of the folded up retaining cord 61 are respectively wound at the first and the second cord-collecting paces 311, 331 defined by the upper and lower boards 31, 33 thereof as shown in FIG. 8. The top edge of the control rotary housing 10 is then fixed (e.g. adhesive fastening) to an appropriate position of a bottom rail 62 of the Venetian blind 60 with the retaining member 20 thereof situated to face outwards as shown in FIG. 9. The free ends 612, 613 of the retaining cord 61 are drawn and adjusted into an equal length before respectively guided from both sides of the bottom rail 62 thereof to thread through a plurality of slats 63 and correspondingly fixed (e.g. tying up) to predetermined positions of a head-rail 64 thereby.

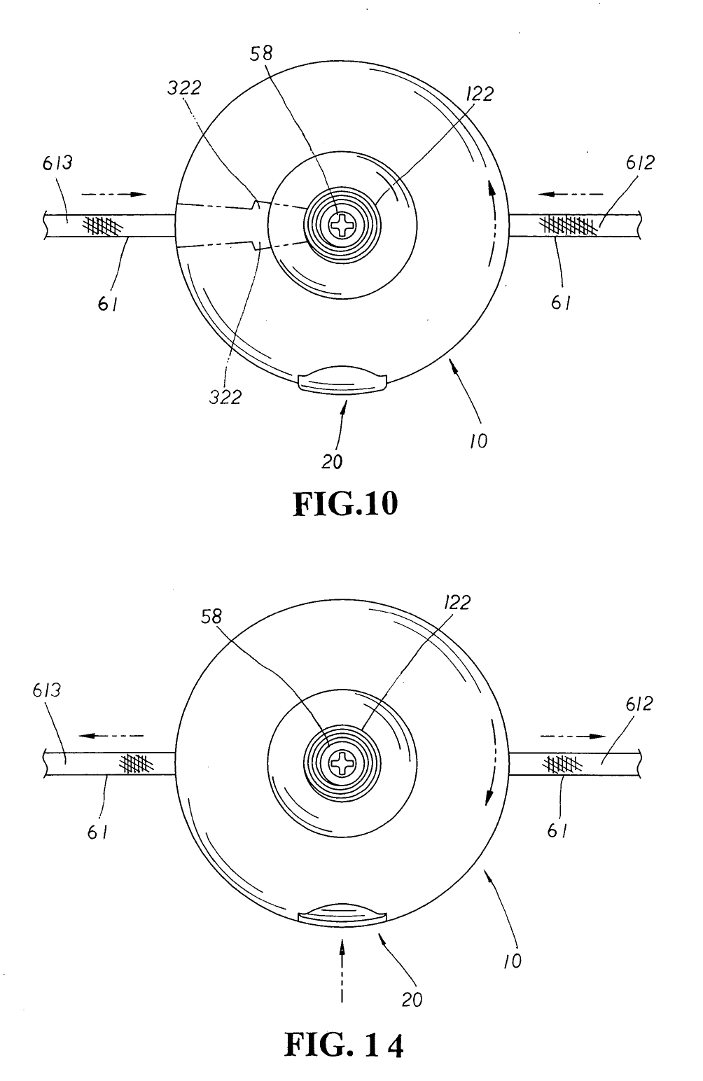

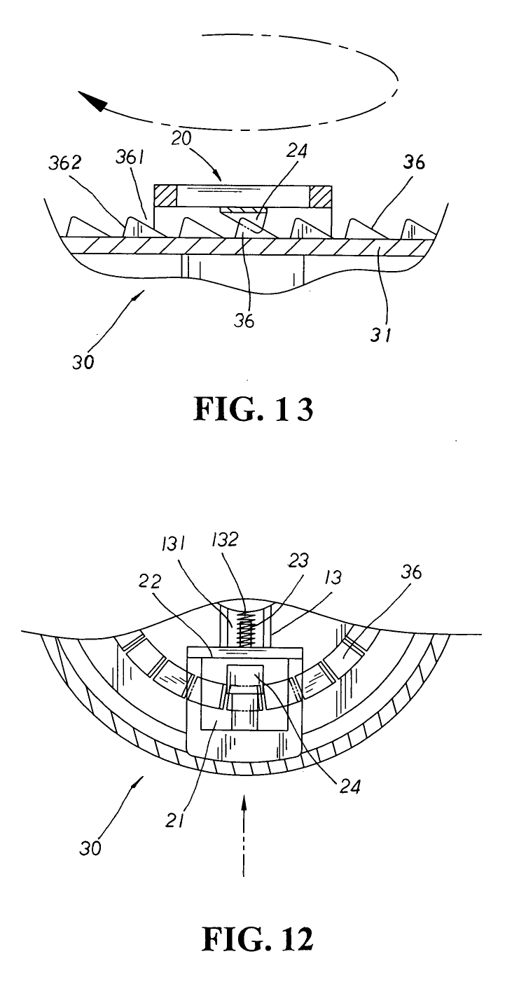

Please refer to FIGS. 10, 11. To collect the Venetian blind 60 thereof, the rotating body 50 is rotated counterclockwise, permitting the free ends 612, 613 of the retaining cord 61 to wind around the recoiling body 30 layers by layers and gather up in coils at the first and second cord-collecting spaces 311, 331 of the upper and lower boards 31, 33 therein respectively so as to sequentially raise and gather upwards the slats 63 of the Venetian 60 in a collected position. To expand the Venetian blind 60 in a sheltering position, the retaining member 20 is persistently pushed inwards as shown in FIG. 12, permitting the engaging rod 23 to abut tight against the elastic element 132 compressed inwards and the toothed blocks 36 of the recoiling body 30 to alternatively position relative to the adjusting toothed blocks 24 of the retaining member 20 thereof as shown in FIG. 13 so that the retaining faces 362 of the toothed blocks 36 thereof can smoothly pass through the oblique faces 25, 26 of the adjusting toothed blocks 24 thereof without being interrupted in the rotating movement thereof. Meanwhile, the bottom rail 62 of the Venetian blind 60 is pulled downwards to actuate the rotating body 50 along with the recoiling body 30 in a clockwise rotation thereof so as to release the retaining cord 61 wound and gathered at the first and second cord-collecting spaces 311, 331 of the upper and lower boards 31, 33 therein as shown in FIG. 14 thereby, permitting the slats 63 of the Venetian blind 60 to speedily expand downwards in an unfolded position thereof. Therefore, via the aforementioned structure, the Venetian blind 60 can be easily collected or expanded without another set of pulling cords applied thereto to avoid the danger of accidentally hurting or strangling children in the family and achieve a convenient and safe application of the present invention.

What is claimed is:

1. A non-pull cord operated Venetian blind structure, including a control rotary housing, a retaining member, a recoiling body, a rotary ring, and a rotating body wherein the control rotary housing is equipped with an assembly hole extending in the middle thereof to be reciprocally registered with the an engaging cylinder and abutting blocks of the recoiling body thereby, and a retaining thru-hole appropriately disposed at one side thereof for the accommodation of the retaining member therein; the recoiling body is made up of a plurality of cord-collecting spaces, and the rotating body is provided with a central coupling rod to be reciprocally guided and located at the engaging cylinder of the recoiling body and the assembly hole of the control rotary housing therein; the rotary ring thereof is mounted at the control rotary housing and the rotating body there-between; whereby, the control rotary housing, the retaining member, the recoiling body, the rotary ring, and the rotating body thereof are reciprocally assembled in an operative mechanism, and the top edge of the control rotary housing thereof can be fixedly mounted to a bottom rail of a Venetian blind; via the recoiling body actuated to rotate by the rotating body thereof, a retaining cord led through slats of the Venetian blind thereof can be smoothly wind around or release from the cord-collecting spaces of the recoiling body thereof so as to collect or expand the slats of the Venetian blind in an easy and speedy manner without any other set of pulling cords applied thereto in the folding/unfolding operation thereof to avoid the danger of accidentally hurting or strangling children in the family and thus to achieve more convenient and safer application of the present invention.

2. The non-pull cord operated Venetian blind structure as claimed in claim 1 wherein the control rotary housing is equipped with a receiving space defining therein, a central protrusive portion with a spring element accommodated therein, an abutting edge annularly defining the bottom end of the protrusive portion thereof, and a pair of protrusive ribs symmetrically extends at the inner top wall of the control rotary housing thereof to define a positioning space there-between for receiving a matched elastic element therein; correspondingly relative to the protrusive ribs thereof is disposed a set of symmetrical first and second locating ribs to define a set of first and second retaining spaces respectively thereby; a cord-passage opening is cut at a predetermined position at the outer periphery of the control rotary housing thereon, and a higher/lower stepwise stop flange is appropriately disposed annularly defining the inner wall of the control rotary housing thereof to form an engaging pace and a movement space thereby wherein an inserting groove with limiting sidewalls defining both sides thereof is set at an appropriate position of the higher/lower stepwise stop flange thereon, and a plurality of positioning blocks are disposed at predetermined positions thereof.

3. The non-pull cord operated Venetian blind structure as claimed in claim 1 wherein the retaining member is equipped with a slot, a stop facet disposed at one side thereof, an engaging rod extending in the middle of the outer edge thereon, and an adjusting toothed block made up of a plurality of oblique faces disposed at one inner side of the slot thereof.

4. The non-pull cord operated Venetian blind structure as claimed in claim 1 wherein the cord-collecting spaces of the recoiling body thereof can be made up of a set of first and second cord-collecting spaces.

5. The non-pull cord operated Venetian blind structure as claimed in claim 1 wherein the engaging cylinder of the recoiling body is disposed in the middle section thereof, and a set of limiting recesses is symmetrically disposed at the surface of the engaging cylinder thereon.

6. The non-pull cord operated Venetian blind structure as claimed in claim 1 wherein the rotary ring has a cord-passing space appropriately disposed thereon, a set of upper and lower coupling sections with inserting flanges protruding at both sides thereof, and a locating block properly extends at the inserting flange of the upper coupling section adjacent to the cord-passing space thereof.

7. The non-pull cord operated Venetian blind structure as claimed in claim 1 wherein the rotating body has an engaging cavity indented at the upper side thereof, a plurality of coupling flanges extending annularly at the edge of the engaging cavity thereon, a limiting ring annularly protruding in the middle section thereon, a central coupling rod with a pair of inserting ribs symmetrically extending at the surface thereon, and an engaging portion with a screw hole therein disposed at the upper end of the coupling rod thereof to be reciprocally locked to a fixing member thereby.

8. The non-pull cord operated Venetian blind structure as claimed in claim 1 wherein the assembly hole of the control rotary housing is made in an annular shape.

9. The non-pull cord operated Venetian blind structure as claimed in claim 3 wherein the oblique faces of the adjusting toothed block of the retaining member are made in right-angled triangular shapes.

10. The non-pull cord operated Venetian blind structure as claimed in claim 4 wherein the first and second cord-collecting spaces of the recoiling body are divided into different spaces via an upper board, a separation board, and a lower board.

11. The non-pull cord operated Venetian blind structure as claimed in claim 4 wherein the recoiling body is made in a three-stepwise disk shape.

12. The non-pull cord operated Venetian blind structure as claimed in claim 10 wherein at the top surface of the upper board of the recoiling body is disposed a plurality of toothed blocks annularly arranged at predetermined positions thereon to form a plurality of registration spaces and retaining faces thereby; around the periphery of the engaging cylinder thereof is annularly disposed a plurality of abutting blocks having a plurality of engaging hooks extending thereon; at a predetermined position of the separation board thereof is cut a cord-passing recess with a symmetrical retaining groove disposed therein.

13. The non-pull cord operated Venetian blind structure as claimed in claim 12 wherein the toothed blocks disposed at the upper board of the recoiling body thereon are made in right-angled triangular shapes.
